(19) United States
(12) Patent Application Publication
(10) Pub. No.: US 2007/0035477 A1
(43) Pub. Date: Feb. 15, 2007

(54) Method of driving plasma display panel and plasma display device driven using the method

(76) Inventors: Dong-Young Lee, Suwon-si (KR); Won-Ju Yi, Suwon-si (KR); Ho-Young Ahn, Suwon-si (KR); Kyoung-Doo Kang, Suwon-si (KR); Soo-Ho Park, Suwon-si (KR); Seok-Gyun Woo, Suwon-si (KR); Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/489,415

(22) Filed: Jul. 18, 2006

(30) Foreign Application Priority Data
Aug. 10, 2005 (KR) 10-2005-0073328

(51) Int. Cl. G09G 3/28

(52) U.S. Cl. 345/63

(57) ABSTRACT

A method of selectively performing a reset discharge in a plasma display panel (PDP) and a plasma display device driven by the method are disclosed. In one embodiment, a display image is represented by a plurality of unit frames, and each unit frame is divided into a plurality of sub-fields, and each of the sub-fields includes, in order, a reset period when all discharge cells are initialized, an address period when a discharge cell that is turned on or off is selected from all discharge cells, and a sustain period when a sustain discharge is performed for a discharge cell selected to be turned on in the address period. Furthermore, a reset discharge is performed to initialize all discharge cells in the reset period of the first sub-field of the unit frame, and to initialize only discharge cells, in which a sustain discharge has been previously performed in the sustain periods, in the reset periods of the sub-fields after the second sub-field.

### CROSS-REFERENCE TO RELATED PATENT APPLICATION

This application claims the benefit of Korean Patent Application No. 10-2005-0073328, filed on Aug. 10, 2005, in the Korean Intellectual Property Office, the disclosure of which is incorporated herein in its entirety by reference. This application also relates to U.S. patent application (Attorney Docket Number: SDIYPL.067AUS) entitled “Method of driving plasma display panel and plasma display device driven using the method,” concurrently filed as this application, which is incorporated by reference.

### BACKGROUND OF THE INVENTION

1. Field of the Invention

The present invention relates to a plasma display panel (PDP), and more particularly, to a method of driving a PDP having a new structure that improves a light-emitting efficiency and reduces the likelihood of a permanent afterimage, and a plasma display device driven by the method.

2. Description of the Related Technology

PDP devices have generally replaced the conventional cathode ray tube (CRT) display devices. PDP devices provide a desired image using visible radiation generated by sealing a discharge gas applying a discharge voltage between two panels in which a plurality of electrodes are formed to generate vacuum ultraviolet radiation, and exciting a phosphor by the vacuum ultraviolet radiation in a predetermined pattern.

FIG. 1 is a partially exploded perspective view of a conventional three-electrode surface discharge type PDP 1. FIG. 2 is a cross-sectional view of the PDP taken along line II-II in FIG. 1.

Referring to FIGS. 1 and 2, the conventional PDP 1 has a first panel 110 and a second panel 120. The first panel 110 includes a front substrate 111, a dielectric layer 115 that covers scan electrode lines 112 and sustain electrode lines 113 at the rear of the first substrate 111, and a protection layer 116 that protects the first dielectric layer 115. The scan electrode lines 112 and sustain electrode lines 113 form a pair of sustain electrodes 114, and include bus electrodes 112a and 113a, and transparent electrodes 112b and 113b, respectively. The bus electrodes 112a and 113a are generally formed of a metal, and the transparent electrodes 112b and 113b are generally formed of a transparent and conductive material such as indium tin oxide (ITO) to increase conductivity.

The second panel 120 includes a second substrate 121, a second dielectric layer 123 that is formed in a direction of the first substrate 111 at the front of the second substrate 121 to cover address electrode lines 122 that cross the scan electrode lines 112 and the sustain electrode lines 113. The second panel 120 also includes the address electrode lines 122, barrier ribs 124 that partition discharge cells Ce at the top of the second dielectric layer 123, a phosphor layer 125 formed in the space partitioned by the barrier ribs 124, and a second protection layer 128 formed in front of the phosphor layer 125 for protecting the phosphor layer 125. A discharge gas is injected in the discharge cells Ce, i.e., the space partitioned by the barrier ribs 124.

The conventional three-electrode surface discharge type PDP 1 illustrated in FIGS. 1 and 2 displays an image by dividing a frame into a plurality of sub fields, and classifying each of the sub fields into a reset period, an address period, and a sustain period. However, the conventional three-electrode surface discharge type PDP 1 has the following disadvantages.

First, a considerable amount of visible radiation emitted from the phosphor layer 128 is absorbed by at least one of i) the scan electrode lines 112 and ii) sustain electrode lines 113 that are arranged beneath the first substrate 110, iii) the first dielectric layer 115 covering the scan electrode lines 112 and sustain electrode lines 113, and iv) the first protection layer 116, thereby reducing light-emitting efficiency.

Second, when the conventional PDP 1 displays an image for a long time, the phosphor layer 128 is ion-sputtered due to charge particles of the discharge gas, thereby causing a permanent afterimage or long-time image retention.

### SUMMARY OF CERTAIN INVENTIVE ASPECTS

One aspect of the present invention provides i) a method of selectively performing a reset discharge in a plasma display panel (PDP) having a new structure that improves light-emitting efficiency and reduces the likelihood of a permanent afterimage, and ii) a plasma display device driven by the method.

Another aspect of the present invention provides a method of driving a plasma display panel (PDP) including i) first and second substrates spaced apart from each other, ii) a barrier rib along with the first and second substrates partitioning discharge cells that are discharge spaces, iii) first and second electrodes extending to cross each other in the barrier rib, iv) a phosphor layer formed in the discharge cells, and v) a discharge gas in the discharge cells. In one embodiment, a display image is represented by a plurality of unit frames and each unit frame is divided into a plurality of sub-fields, and each of the sub-fields is divided into a reset period when all discharge cells are initialized, an address period when a discharge cell that is turned on or off is selected from all discharge cells, and a sustain period when a sustain discharge is performed for a discharge cell selected to be turned on during the address period according to gray-level weights assigned to each of the sub-fields. Furthermore, a reset discharge is performed to initialize all discharge cells in the reset period of the first sub-field of the unit frame, and to initialize only discharge cells, in which a sustain discharge has been performed in the sustain periods, in the reset periods of the sub-fields after the second sub-field.

In one embodiment, a rising pulse and a falling pulse may be applied to the first electrode in the reset period of the first sub-field, and the falling pulse is applied to the first electrode in the reset periods of the sub-fields after the second sub-field.

In one embodiment, the rising pulse and the falling pulse may be ramp pulses.

In one embodiment, a bias voltage may be applied to the second electrode when the falling pulse is applied in the reset periods of each of the sub-fields.

In one embodiment, a scan pulse sequentially having a high level and a low level may be applied to the first electrode, and a display data signal may be applied to the second electrode in accordance with the low level electric potential of the scan pulse in the address periods of each of the sub-fields.

In one embodiment, a sustain pulse alternately having a high level and a low level may be applied to the first electrode, and an intermediate level between the high level and the low level of the sustain pulse may be applied to the second electrode in the sustain periods of each of the sub-fields.

Another aspect of the present invention provides a method of driving a PDP including i) first and second substrates spaced apart from each other, ii) a barrier rib along with the first and second substrates partitioning discharge cells that are discharge spaces, iii) first and second electrodes extending in a direction in the barrier rib, iv) a third electrode extending to cross the first and second electrodes in the barrier rib, v) a phosphor layer formed in the discharge cells, and vi) a discharge gas in the discharge cells. In one embodiment, each unit frame is divided into a plurality of sub-fields, and each of the sub-fields is divided into a reset period when all discharge cells are initialized, an address period when a discharge cell that is turned on or off is selected from all discharge cells, and a sustain period when a sustain discharge is performed for a discharge cell selected to be turned on in the address period according to gray-level weights assigned to each of the sub-fields. Furthermore, a reset discharge is performed to initialize all discharge cells in the reset period of the first sub-field of the unit frame, and to initialize only discharge cells, in which a sustain discharge has been performed in the sustain periods, in the reset periods of the sub-fields after the second sub-field.

In one embodiment, a rising pulse and a falling pulse may be applied to the first electrode in the reset period of the first sub-field, and the falling pulse may be applied to the first electrode in the reset periods of the sub-fields after the second sub-field.

In one embodiment, the rising pulse and the falling pulse may be ramp pulses.

In one embodiment, a bias voltage may be applied to the second electrode when the falling pulse is applied in the reset periods of each of the sub-fields.

In one embodiment, a scan pulse sequentially having a high level and a low level may be applied to the first electrode, a display data signal may be applied to the third electrode in accordance with the low level electric potential of the scan pulse, and a bias voltage may be applied to the second electrode in the address periods of each of the sub-fields.

In one embodiment, sustain pulses alternately having a high level and a low level may be applied to the first electrode and the second electrode in the sustain periods of each of the sub-fields.

Another aspect of the present invention provides a plasma display apparatus comprising: i) a PDP including first and second substrates spaced apart from each other, a barrier rib along with the first and second substrates partitioning discharge cells that are discharge spaces, first and second electrodes extending to cross each other in the barrier rib, a phosphor layer formed in the discharge cells, a discharge gas in the discharge cells, and ii) drivers applying a diving signal that is divided into reset, address, and sustain periods to each of the first and second electrodes to drive the PDP. In one embodiment, each unit frame is divided into a plurality of sub-fields, and each of the sub-fields is divided into the reset period when all discharge cells are initialized, the address period that selects a discharge cell when a discharge cell that is turned on or off is selected from all discharge cells, and the sustain period when a sustain discharge is performed for a discharge cell selected to be turned on in the address period according to gray-level weights assigned to each of the sub-fields. In one embodiment, the drivers are divided into a first driver that applies the driving signal to the first electrode, and a second driver that applies the driving signal to the second electrode, the first driver applies a rising pulse and a falling pulse in the reset period of the first sub-field, and applies the falling pulse in the reset periods of the sub-fields after the second sub-field.

In one embodiment, the rising pulse and the falling pulse may be ramp pulses.

In one embodiment, the second driver may apply a bias voltage when the falling pulse is applied in the reset periods of each of the sub-fields.

In one embodiment, the first driver may apply a scan pulse sequentially having a high level and a low level, and the second driver may apply a display data signal in accordance with the low level of the scan pulse in the address periods of each of the sub-fields.

In one embodiment, the first driver may apply a sustain pulse alternately having a high level and a low level, and the second driver may apply an intermediate level between the high level and the low level of the sustain pulse in the sustain periods of each of the sub-fields.

Another aspect of the present invention provides a plasma display apparatus comprising: i) a PDP including first and second substrates spaced apart from each other, a barrier rib along with the first and second substrates partitioning discharge cells that are discharge spaces, first and second electrodes extending in a direction in the barrier rib, a third electrode extending to cross the first and second electrodes in the barrier rib, a phosphor layer formed in the discharge cells, a discharge gas in the discharge cells, and ii) drivers applying a diving signal that is divided into reset, address, and sustain periods to each of the first, second, and third electrodes to drive the PDP. In one embodiment, each unit frame is divided into a plurality of sub-fields, and each of the sub-fields is divided into the reset period when all discharge cells are initialized, the address period that selects a discharge cell when a discharge cell that is turned on or off is selected from all discharge cells, and the sustain period when a sustain discharge is performed for a discharge cell selected to be turned on in the address period according to gray-level weights assigned to each of the sub-fields. In one embodiment, the drivers are divided into a first driver that applies the driving signal to the first electrode, a second driver that applies the driving signal to the second electrode, and a third driver that applies the driving signal to the third electrode, the first driver applies a rising pulse and a falling pulse in the reset period of the first sub-field, and applies the falling pulse in the reset periods of the sub-fields after the second sub-field.

In one embodiment, the rising pulse and the falling pulse may be ramp pulses.

In one embodiment, the second driver may apply a bias voltage when the falling pulse is applied in the reset periods of each of the sub-fields.

In one embodiment, the first driver may apply a scan pulse sequentially having a high level and a low level, the third driver may apply a display data signal in accordance with the low level of the scan pulse, and the second driver may apply the bias voltage in the address periods of each of the sub-fields.

In one embodiment, the first and second drivers may apply sustain pulses alternately having a high level and a low level in the sustain periods of each of the sub-fields.

### BRIEF DESCRIPTION OF THE DRAWINGS

Embodiments of the present invention will become more apparent by describing in detail exemplary embodiments thereof with reference to the attached drawings.

FIG. 1 is a partially exploded perspective view of a conventional three-electrode surface discharge type plasma display panel (PDP).

FIG. 2 is a cross-sectional view of the PDP of FIG. 1 taken along line II-II in FIG. 1.

FIG. 3 is a perspective view of a PDP having improved light-emitting efficiency and reduced likelihood of a permanent afterimage, which uses a method of driving the PDP according to an embodiment of the present invention.

FIG. 4 is a cross-sectional view of the PDP of FIG. 3 taken along line IV-IV in FIG. 3.

FIG. 5 illustrates discharge cells and electrodes illustrated in FIGS. 3 and 4.

FIG. 6 is a timing diagram for explaining a method of driving the PDP illustrated in FIG. 3.

FIG. 7 is a block diagram of the PDP illustrated in FIG. 3 and a plasma display apparatus for driving the PDP according to an embodiment of the present invention.

FIG. 8 illustrates waveforms of a driving signal for driving the PDP illustrated in FIG. 3 according to an embodiment of the present invention.

FIG. 9 is a perspective view of a PDP having improved light-emitting efficiency and reduced likelihood of a permanent afterimage, which uses a method of driving the PDP according to another embodiment of the present invention.

FIG. 10 is a cross-sectional view of the PDP of FIG. 9 taken along line X-X in FIG. 9.

FIG. 11 illustrates discharge cells and electrodes illustrated in FIGS. 9 and 10.

FIG. 12 is a block diagram of the PDP illustrated in FIG. 9 and a plasma display apparatus for driving the PDP according to another embodiment of the present invention.

FIG. 13 illustrates waveforms of a driving signal for driving the PDP illustrated in FIG. 9 according to another embodiment of the present invention.

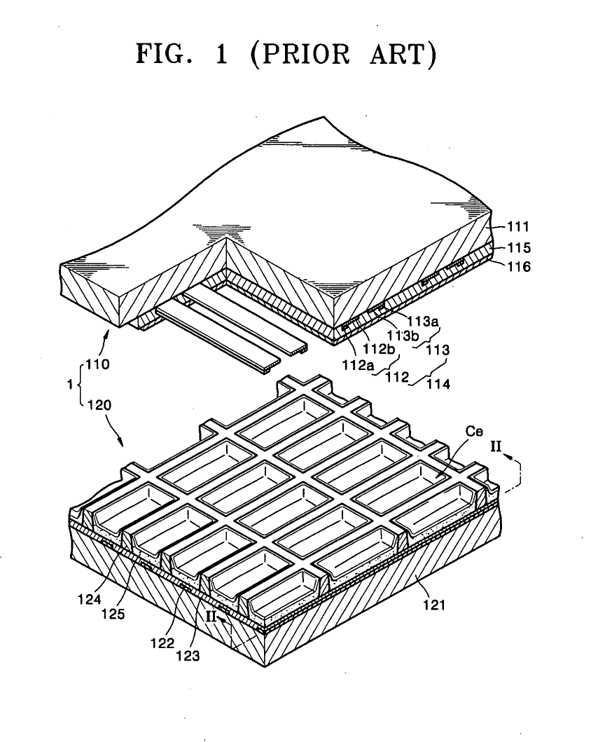

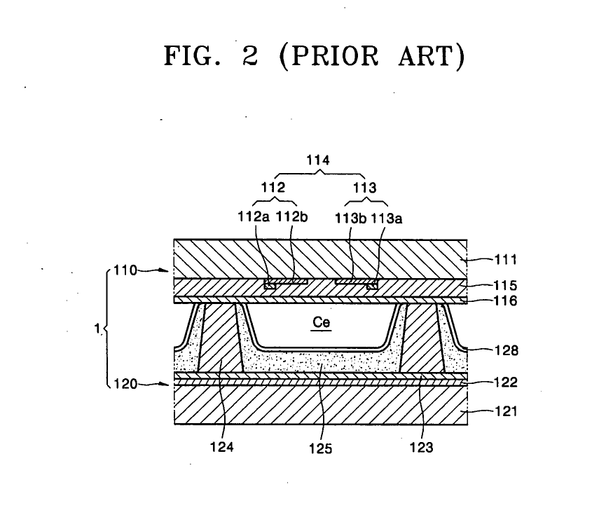

### DETAILED DESCRIPTION OF CERTAIN INVENTIVE EMBODIMENTS

Embodiments of the present invention will now be described more fully with reference to the accompanying drawings, in which exemplary embodiments of the invention are shown.

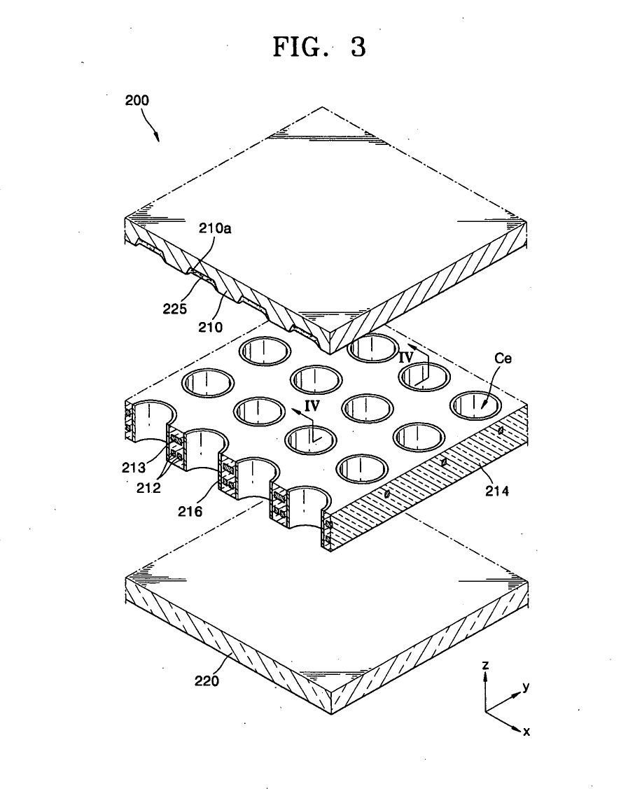

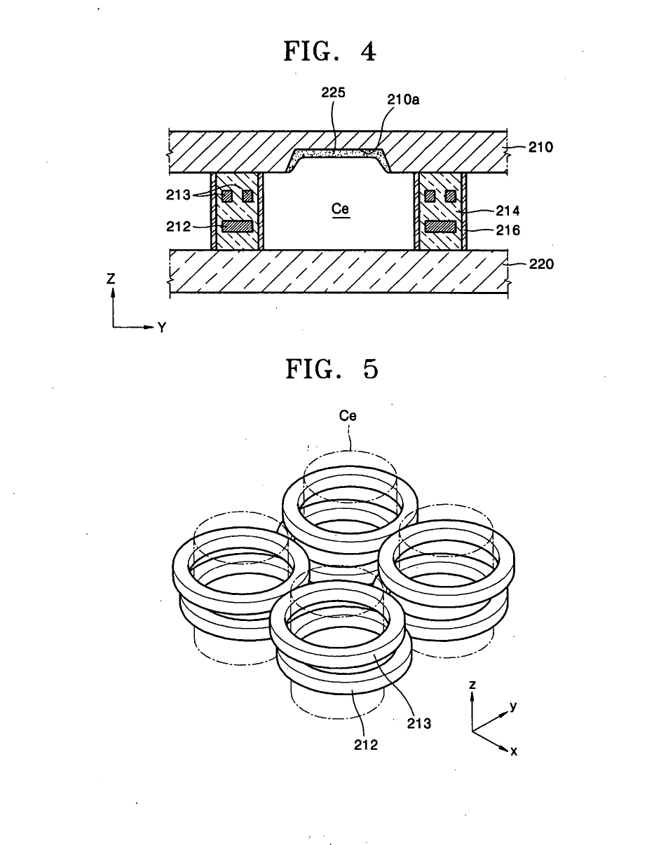

FIG. 3 is a perspective view of a plasma display panel (PDP) 200 having improved light-emitting efficiency and reduced likelihood of a permanent afterimage or long-time image retention, which uses a method of driving the PDP according to an embodiment of the present invention. FIG. 4 is a cross-sectional view of the PDP of FIG. 3 taken along line Iv-IV in FIG. 3. FIG. 5 illustrates discharge cells and electrodes illustrated in FIGS. 3 and 4.

Referring to FIGS. 3 through 5, the PDP 200 includes a first substrate 210, a second substrate 220, a barrier rib 214, a first electrode 212, a second electrode 213, a phosphor layer 225, a protection layer 216, and a discharge gas (not shown).

The first and second substrates 210 and 220 are spaced apart from each other. In one embodiment, the barrier rib 214 may be formed in a single body as illustrated in the drawings, or be divided into a front barrier rib and a rear barrier rib that are attached to the first and second substrates 210 and 220, respectively. The barrier rib 214 along with the first and second substrates 210 and 220 partition the discharge cells Ce that is spaces for performing a discharge. In one embodiment, the discharge cells Ce may be formed in an aperture having a circular cross-section in the barrier rib 214. In another embodiment, the discharge cells Ce may have triangular, rectangular, pentagonal, or oval cross-sections. In one embodiment, the barrier rib 214 may partition the discharge cells Ce in the form of a matrix. If the barrier rib 214 forms a plurality of discharge spaces, the discharge cells Ce may be formed in a variety of patterns such as a waffle pattern, a delta pattern, etc. The barrier rib 214 is generally formed of a dielectric material.

In one embodiment, the first and second electrodes 212 and 213, spaced apart from each other, are formed in the barrier rib 214. In one embodiment, the first and second electrodes 212 and 213 may surround entirely the discharge cells Ce. In another embodiment, the discharge cells Ce may be partly surrounded by the first and second electrodes 212 and 213. The first and second electrodes 212 and 213 extend in x and y directions, respectively. In one embodiment, the first and second electrodes 212, 213 are sequentially arranged in a direction (a z direction) from the first substrate 210 to the second substrate 220.

In one embodiment, the first protection layer 216 formed of MgO is arranged on the exterior surface of the barrier rib 214 forming the discharge cells Ce. When a discharge is performed, the first protection layer 216 protects the first and second electrodes 212 and 213, and the barrier rib 214 discharges a secondary electron, making the discharge easy.

In one embodiment, the phosphor layer 225 is formed in the first substrate 210, and, more specifically, in a groove 210a formed in the first substrate 210 in a direction of the second substrate 220. In another embodiment, the phosphor layer 225 may be formed in a groove (not shown) formed in the second substrate 220 in a direction of the first substrate 210, or be formed on both first and second substrates 210 and 220.

In one embodiment, the discharge gas, which is injected into the discharge cells Ce, is a mixture of xenon (Xe) under about 10% or over about 10% and one or two out of neon (Ne), helium (He), and argon (Ar).

In one embodiment, the first and second substrates 210 and 220 are formed of a transparent material such as glass. The second substrate 220 is spaced apart from the first substrate 210. In one embodiment, the first and second substrates 210 and 220 are formed of the same material. In another embodiment, the first and second substrates 210 and 220 have the same coefficient of thermal expansion.

When the discharge is performed, the barrier rib 214 prevents the first and second electrodes 212 and 213 from electrically connecting to each other, and being damaged due to collisions with charge particles. In one embodiment, the barrier rib 214 is formed of a dielectric material that induces charge particles and accumulates wall charges. The dielectric material may be PbO, B₂O₃, SiO₂, etc.

A predetermined voltage is applied to each of the first and second electrodes 212 and 213 to perform the discharge. In one embodiment, the first and second electrodes 212 and 213 may be formed of a highly conductive material such as Ag, Cu, Cr, etc.

In one embodiment, the phosphor layer 225 is formed by coating a phosphor paste including one of a red light-emitting phosphor material, a green light-emitting phosphor material, and a blue light-emitting phosphor material, a solvent, and a binder on the groove 210a formed on the first substrate 210, drying the coated groove, and forming a metal. The red light-emitting phosphor material may be Y(V,P)O₄:Eu, the green light-emitting phosphor material may be Zn₂SiO₄:Mn, YBO₃:Tb, and the blue light-emitting phosphor material may be BAM:Eu.

A second protection layer (not shown) formed of MgO may be formed in the front (a-z direction) of the phosphor layer 225. When the discharge is performed in the discharge cells Ce, the second protection layer prevents the phosphor layer 225 from being deteriorated due to collisions with discharge particles, and discharges the secondary electron, making the discharge easier.

The PDP 200 illustrated in FIGS. 3 through 5 are advantageous to the conventional PDP 1 as follows.

First, since the PDP 200 does not require additional dielectric layers for the discharge electrodes 212 and 213, the visible radiation generated by the discharge is directly emitted through the first substrate 210 and/or the second substrate 220, such that the light-emitting efficiency is increased, and a transparent electrode such as ITO is not required.

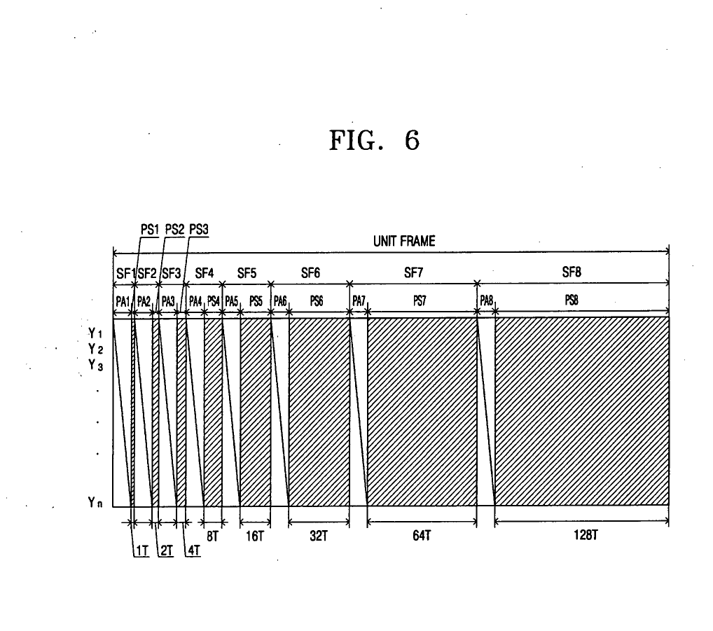

Second, the first and second electrodes 212 and 213 are formed in the barrier rib 214 and around the discharge cells Ce so that an electric field focuses on the center of the discharge cells Ce. Although the PDP 200 displays an image for a long time, the phosphor layers 225 is not ion-sputtered due to charge particles of the discharge gas, thereby avoiding a permanent afterimage. Also, the discharge is performed in every space of the discharge cells Ce, thereby increasing a response speed and discharge efficiency. [0063] FIG. 6 is a timing diagram for explaining a method of driving the PDP illustrated in FIG. 3. A display image is generally represented by a plurality of unit frames. In one embodiment, as shown in FIG. 6, each unit frame is divided into 8 sub-fields SF1 through SF8. Each of the sub-fields SF1 through SF8 is divided into a reset period (not shown in FIG. 6), an address period PA1 through PA8, and a sustain period PS1 through PS8, respectively. The reset period equally initializes all discharge cells Ce, each of the address periods PA1 through PA8 selects a discharge cell that is turned on or off from all discharge cells Ce. Furthermore, each of the sustain period PS1 through PS8 performs a sustain discharge for a discharge cell selected to be turned on in the address periods PA1 through PA8 according to gray-level weights 1T, 2T, 4T, 8T, 16T, 32T, 64T, and 128T assigned to each of the sub-fields SF1 through SF8. In one embodiment, the PDP 200 is driven by a time-division driving method in which a driving signal is applied according to the reset period, the address periods PA1 through PA8, and the sustain periods PS1 through PS8 of each of the sub-fields SF1 through SF8.

The sub-fields SF1 through SF8, the reset period (not shown), the address period PA1 through PA8, the sustain discharge period PS1 through PS8, and the gray-level weights 1T, 2T, 4T, 8T, 16T, 32T, 64T, and 128T are not necessarily restricted to the above description. For example, the number of the sub-fields of the unit frame may be less than or greater than 8, and the assignment of the gray-level weights to the sub-fields may be modified according to an embodiment.

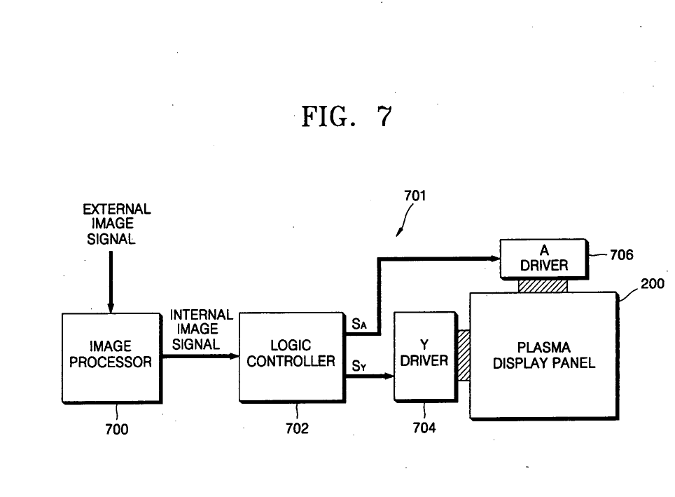

FIG. 7 is a block diagram of the PDP 200 illustrated in FIG. 3 and a plasma display apparatus 701 for driving the PDP according to an embodiment of the present invention. The PDP 200 includes two electrodes which are arranged in the barrier rib 214. Therefore, the plasma display apparatus 701 has a simpler structure than the convention PDP 1 including three electrodes.

Referring to FIG. 7, the plasma display apparatus 701 includes an image processor 700, a logic controller 702, a Y driver 704, an A driver 706, and the PDP 200.

The image processor 700 converts an external analog image signal such as a PC signal, a DVD signal, a video signal, a TV signal, etc., into a digital signal, image-processes the converted digital signal, and outputs an internal image signal. In one embodiment, the internal image signal includes 8-bit red (R), green (G), and blue (B) image data, a clock signal, and vertical and horizontal synchronization signals.

The logic controller 702 outputs a Y driving control signal SY and an A driving control signal SA by processing, for example, a gamma correction, an automatic power control (APC) for the internal image signal received from the image processor 700.

The Y driver 704 receives the Y driving control signal SY from the logic controller 702, and applies a driving signal to the first electrode 212. The A driver 706 receives the A driving control signal SA from the logic controller 702, and applies a driving signal to the second electrode 213. Hereinafter the first electrode 212 and the second electrode 213 will now be referred to as a Y electrode and an A electrode, respectively.

In one embodiment, the Y driver 704 applies a rising pulse and a falling pulse to the Y electrode in order to initialize all discharge cells in a reset period PR1 of the first sub-field SF1 of the unit frame including a plurality of sub-fields. Furthermore, the Y driver 704 applies the falling pulse to the Y electrode in order to initialize only discharge cells, in which a sustain discharge has been performed in the sustain periods PS1 through PS7, in reset periods PR2 through PR8 of the sub-fields SF2 through SF8. In one embodiment, the rising pulse and the falling pulse may be ramp pulses, or parabolic pulses in which an instant inclination is reduced with time. In another embodiment, the Y driver 704 applies a reset discharge pulse including at least one monotonically increasing portion and at least one monotonically decreasing portion. This reset pulse can be used in other embodiments. If the rising pulse and the falling pulse are applied in the reset period PR1 of the first sub-field SF1, wall charges are accumulated around the Y electrode due to the applied rising pulse, so that a reset discharge is performed in all the discharge cells, and the wall charges are erased from the Y electrode due to the applied falling pulse, so that the reset discharge is performed in all the discharge cells. If the falling pulse is applied in the reset periods PR2 through PR8 of the sub-fields SF2 through SF8, since wall charges are already accumulated in the discharge cell in which the sustain discharge has already been performed in the sustain periods PS1 through PS7, the applied falling pulse results in the erasure of the accumulated wall charges, and the reset discharge is performed in all the discharge cells. However, since wall charges are not accumulated in a discharge cell in which the sustain discharge has not been performed in the sustain periods PS1 through PS7, the applied falling pulse does not result in the erasure of the accumulated wall charges, the reset discharge is not performed in all the discharge cells. That is, the reset discharge is selectively performed according to whether the sustain discharge has been performed. Therefore, one embodiment of the present invention can make the reset periods PR2 through PR8 of the sub-fields SF2 through SF8 shorter than the rest period PR1 of the sub-field SF1, and obtain a longer address period and increase the address period preferred in a high quality PDP. Also, one embodiment of the present invention does not generate an unnecessary reset light, thereby improving a contrast of the PDP. The Y driver 704 applies a scan pulse to the address periods PA1 through PA8, and applied a sustain pulse to the sustain periods PS1 through PS8.

The A driver 706 applies a display data signal to the address periods PA1 through PA8 in accordance with the scan pulse. The address discharge is performed in the address periods PA1 through PA8 using the display data signal and the scan pulse.

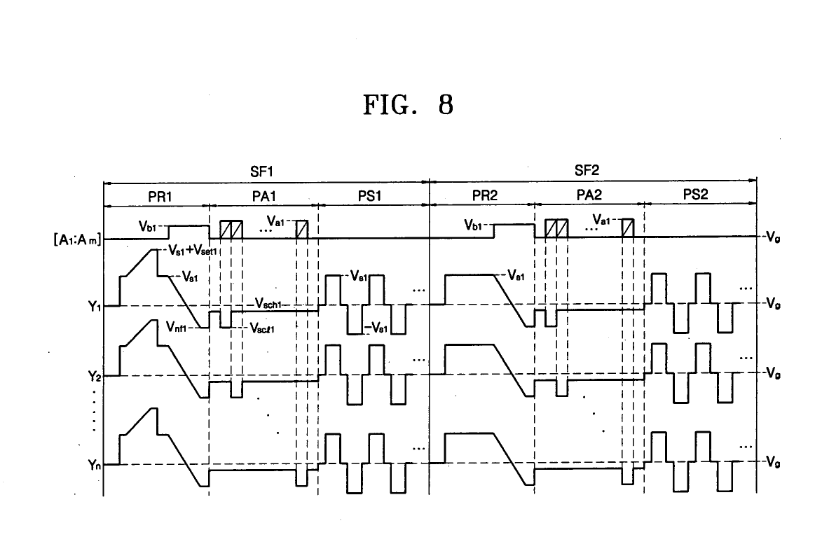

FIG. 8 illustrates waveforms of a driving signal for driving the PDP illustrated in FIG. 3 according to an embodiment of the present invention. Referring to FIGS. 3 through 8, the reset periods PR1 through PR8 are periods for initializing all the discharge cells in which the rising pulse and the falling pulse are applied to the Y electrode in the reset period PR1 of the sub-field SF1. In one embodiment, the falling pulse is applied to the Y electrode in the reset periods PR2 through PR8 of the sub-fields SF2 through SF8, a low level voltage, for example, a ground voltage Vg, is applied to the A electrode in the reset periods PR1 through PR8 of the sub-fields SF1 through SF8, whereas a bias voltage Vb1 is applied to the A electrode when the falling pulse is applied. The rising pulse rises from a sustain discharge voltage Vs1 to a rising maximum voltage Vs1+Vset1, and the falling pulse falls from the sustain discharge voltage Vs1 to a falling minimum voltage Vnf1. The rising pulse applied in the reset period PR1 of the sub-field SF1 results in the accumulation of negative wall charges around the Y electrode in all the discharge cells, so that the rest discharge is performed between the Y electrode and the A electrode. The falling pulse applied in the reset period PR1 of the sub-field SF1 results in the erasure of the negative wall charges accumulated around the Y electrode in all the discharge cells, so that the rest discharge is performed between the Y electrode and the A electrode. When the falling pulse is applied in the reset periods PR2 through PR8 of the sub-fields SF2 through SF8, the wall charges are accumulated in each of electrodes, in particular, the Y electrode, of the discharge cell in which the sustain discharge has been performed in the sustain periods PS1 through PS7, thereby erasing the wall charges and performing the reset discharge between the Y electrode and the A electrode. The reset discharge initializes the state of the wall charges of all the discharge cells so that the state of the wall charges can be suitable for the address discharge performed in the address periods. Since the wall charges are not accumulated around the Y electrode of a discharge cell in which the sustain discharge has not been performed in the sustain periods PS1 through PS7, the application of the falling pulse does not result in the performance of the reset discharge. That is, since the discharge cells are already initialized, it is not necessary to initialize the discharge cells again. Therefore, the driving signal according to one embodiment of the present invention forms the state of wall charges suitable for the performance of the address discharge after the reset periods PR1 through PR8 in the discharge cells.

The address periods PA1 through PA8 are periods that select a discharge cell that is turned on or off from all the discharge cells during the address discharge. Although a write discharge method is used to perform the address discharge in a discharge cell that is turned on with reference to FIG. 8, it is not necessarily restricted thereto. That is, a selective erasure method is used to perform the address discharge in all the discharge cells, and an erasure method is performed in a discharge cell that is turned off. In the write discharge method, a scan pulse sequentially having a high level electric potential Vsch1 and a low level electric potential Vscl1 is applied to the Y electrode, and the display data signal having a positive electric potential Va1 is applied to the A electrode in accordance with the low level electric potential Vscl1 of the scan pulse. The application of the scan pulse and the display data signal results performing the address discharge between the Y electrode and the A electrode of the discharge cells. After the address discharge is performed, the accumulation of positive wall charges around the Y electrode and negative wall charges around the A electrode.

The sustain periods PS1 through PS8 are periods that perform the sustain discharge according to the gray-level weights assigned to the discharge cell that is turned on. As shown in FIG. 8, a sustain pulse alternately having the high level Vs1 and a low level −Vs1 is applied to the Y electrode, and an intermediate electric potential Vg between the high level Vs1 and the low level −Vs1 of the sustain pulse is applied to the A electrode. A high level electric potential of the sustain pulse is referred to as a sustain discharge voltage Vs1. The number of sustain pulses is proportional to the gray-level weights. That is, a gray-level is changed in proportion to the gray-level weights assigned by the number of sustain discharges. If the sustain pulse of the high level Vs1 is applied to the Y electrode, the sustain discharge is performed by the positive wall charges accumulated around the Y electrode of the discharge cells, the negative wall charges accumulated around the A electrode, the electric potential Vs1 applied to the Y electrode, and the electric potential Vg applied to the A electrode. After the sustain discharge is performed, the positive wall charges and the negative wall charges are accumulated around the A electrode and the Y electrode, respectively. If the sustain pulse of the low level −Vs1 is applied to the Y electrode, the sustain discharge is performed by the negative wall charges accumulated around the Y electrode of the discharge cells, the positive wall charges accumulated around the A electrode, the electric potential −Vs1 applied to the Y electrode, and the electric potential Vg applied to the A electrode. After the sustain discharge is performed, the negative wall charges and the positive wall charges are accumulated around the A electrode and the Y electrode, respectively. Therefore, the sustain discharge is continuously performed according to the number of sustain pulses determined by the gray-level weights.

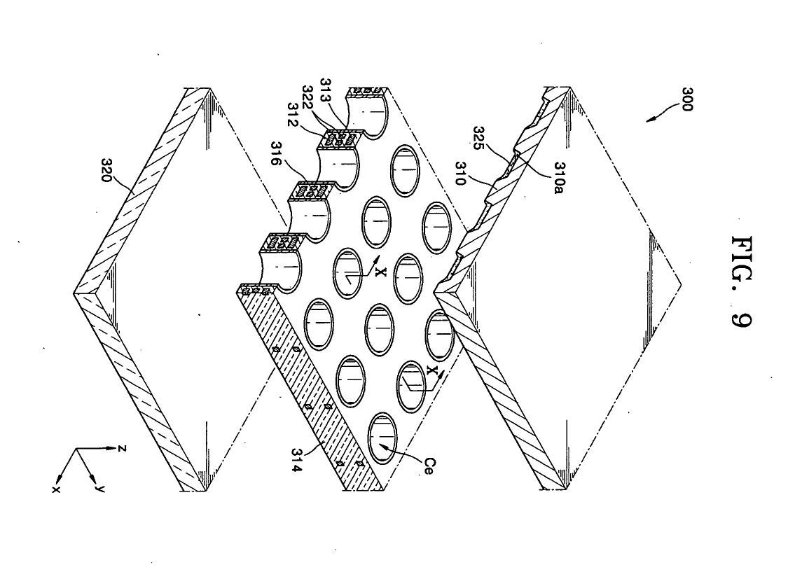

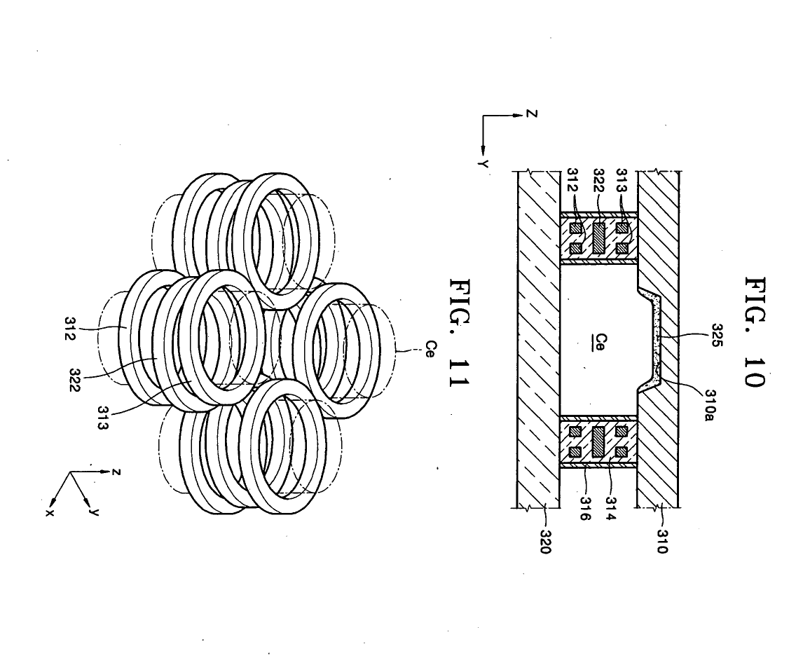

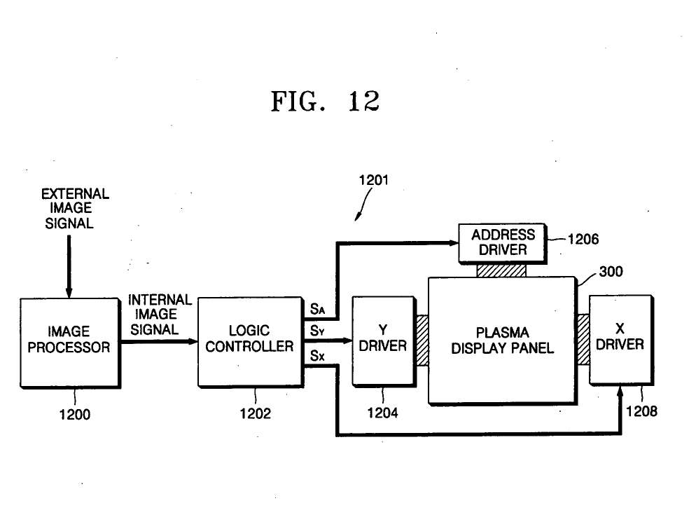

FIG. 9 is a perspective view of a PDP 300 having improved light-emitting efficiency and reduced likelihood of a permanent afterimage, which uses a method of driving the PDP according to another embodiment of the present invention. FIG. 10 is a cross-sectional view of the PDP of FIG. 9 taken along line X-X in FIG. 9. FIG. 11 illustrates discharge cells and electrodes illustrated in FIGS. 9 and 10.

The PDP 300 is similar to the PDP 200 illustrated in FIGS. 3 through 5 except that the PDP 300 includes three electrodes, whereas the PDP 200 includes two electrodes. The difference between the PDP 300 and the PDP 200 will now be described.

Referring to FIGS. 9 through 11, the PDP 300 includes a first substrate 310, a second substrate 320, a barrier rib 314, a first electrode 312, a second electrode 313, a third electrode 322, a phosphor layer 325, a first protection layer 316, and a discharge gas.

The descriptions of the first substrate 310, the second substrate 320, the barrier rib 314, the phosphor layer 325, the first protection layer 316, and the discharge gas are the same as the descriptions with reference to FIGS. 3 through 5.

In one embodiment, the first, second, and third electrodes 312, 313, and 322 are spaced apart from one another in the barrier rib 314. In one embodiment, the first, second, and third electrodes 312, 313, and 322 may surround the entire discharge cells Ce. In another embodiment, the discharge cells Ce may be partly surrounded by the first, second, and third electrodes 312, 313, and 322. The first and second electrodes 312 and 313 extend in a direction (for example, an x direction in FIG. 11), and the third electrode 322 extends in a direction (for example, a y direction in FIG. 11) to cross the first and second electrodes 312 and 313. The second electrode 313, the third electrode 322, and the first electrode 312, not necessarily restricted thereto, are sequentially arranged in a direction (a-z direction) from the first substrate 310 to the second substrate 320, and may be differently arranged according to an embodiment.

The PDP 300 illustrated in FIGS. 9 through 11 has the same advantage as the PDP 200 illustrated in FIGS. 3 through 5.

FIG. 12 is a block diagram of the PDP illustrated in FIG. 9 and a plasma display apparatus 1201 for driving the PDP according to another embodiment of the present invention. The plasma display apparatus 1201 illustrated in FIG. 12 is similar to the plasma display apparatus 701. The difference between both plasma display apparatuses will now be described.

Referring to FIGS. 9 through 12, the plasma display apparatus 1201 includes an image processor 1200, a logic controller 1202, a Y driver 1204, an A driver 1206, an X driver 1208, and the PDP 300.

The image processor 1200 performs the same function as the image processor 700.

The logic controller 1202 outputs a Y driving control signal SY, an A driving control signal SA, and an X driving control signal SX by processing, for example, a gamma correction, an automatic power control (APC) for an internal image signal received from the image processor 1200.

The Y driver 1204 receives the Y driving control signal SY from the logic controller 1202, and applies a driving signal to the first electrode 312. The X driver 1208 receives the X driving control signal SX from the logic controller 1202, and applies a driving signal to the second electrode 313. The A driver 1206 receives the A driving control signal SA from the logic controller 1202, and applies a driving signal to the third electrode 322. Hereinafter the first electrode 312, the second electrode 313, and the third electrode 322 will now be referred to as a Y electrode, an X electrode, and an A electrode, respectively.

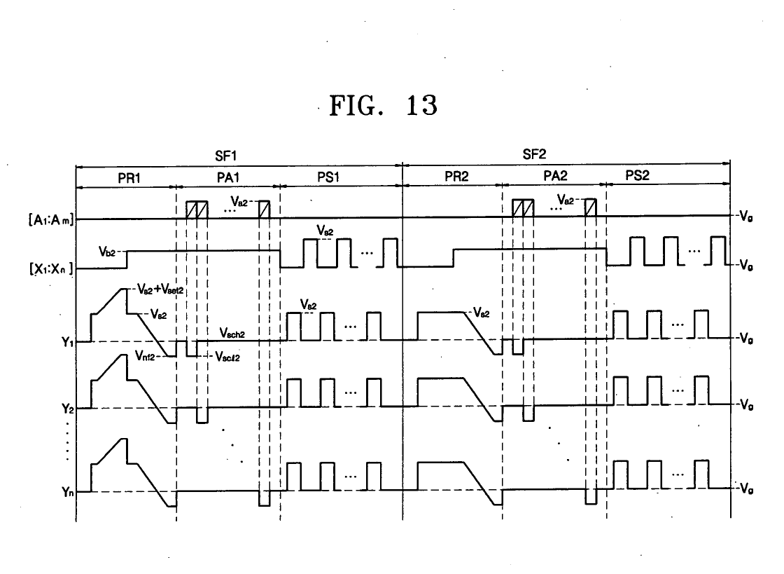

In one embodiment, as discussed above with regard to the embodiment of FIGS. 3-8, the Y driver 1204 applies a rising pulse and a falling pulse to the Y electrode in order to initialize all discharge cells in a reset period PR1 of the first sub-field SF1 of the unit frame including a plurality of sub-fields. Furthermore, the Y driver 1204 applies the falling pulse to the Y electrode in order to initialize only discharge cells in which a sustain discharge has been performed in the sustain periods PS1 through PS7 in reset periods PR2 through PR8 of the sub-fields SF2 through SF8 (see FIG. 13).

In one embodiment, the Y driver 1204 sequentially applies scan pulses of the high level Vsch2 and the low level V in the address periods PA1 through PA8, and alternately applies sustain pulses of the high level Vs2 and the low level Vg in the sustain periods PS1 through PS8 (see FIG. 13).

In one embodiment, the X driver 1208 applies the bias voltage Vb2 from the reset periods PR1 through PR8 in which the falling pulse is applied to the address periods PA1 through PA8, and alternately applies the sustain pulses of the high level Vs2 and the low level Vg in the sustain periods PS1 through PS8 (see FIG. 13). The sustain pulses output by the Y driver 1204 and the X driver 1208 alternates, thereby performing the sustain discharge in the discharge cells.

In one embodiment, the A driver 1206 applies a display data signal to the address periods PA1 through PA8 in accordance with the scan pulse (see FIG. 13). The address discharge is performed in the address periods PA1 through PA8 using the display data signal and the scan pulse.

FIG. 13 illustrates waveforms of a driving signal for driving the PDP illustrated in FIG. 9 according to another embodiment of the present invention. The method described in FIG. 9 uses a time division gray level expression as illustrated in FIG. 6. The driving signal of FIG. 13 is similar to the driving signal of FIG. 8. The difference between both driving signals will now be described.

Referring to FIGS. 9 through 13, the reset periods PR1 through PR8 are periods for initializing all the discharge cells in which the rising pulse and the falling pulse are applied to the Y electrode in the reset period PR1 of the sub-field SF1. In one embodiment, the falling pulse is applied to the Y electrode in the reset periods PR2 through PR8 of the sub-fields SF2 through SF8, a low level voltage, for example, a ground voltage Vg, is applied to the A electrode in the reset periods PR1 through PR8 of the sub-fields SF1 through SF8, whereas a bias voltage Vb2 is applied and the low level voltage Vg is applied to the Y electrode during the application of the falling pulse. The rising pulse rises from a sustain discharge voltage Vs2 to a rising maximum voltage Vs2+Vset2, and the falling pulse falls from the sustain discharge voltage Vs1 to a falling minimum voltage Vnf2. The rising pulse applied in the reset period PR1 of the sub-field SF1 results in the accumulation of negative wall charges around the Y electrode in all the discharge cells, so that the rest discharge is performed between the Y electrode and the A electrode and between the Y electrode and the X electrode. The falling pulse applied in the reset period PR1 of the sub-field SF1 results in the erasure of the negative wall charges accumulated around the Y electrode in all the discharge cells, so that the rest discharge is performed between the Y electrode and the A electrode and between the Y electrode and the X electrode. When the falling pulse is applied in the reset periods PR2 through PR8 of the sub-fields SF2 through SF8, the wall charges are accumulated in each of electrodes, in particular, the Y electrode, of the discharge cell in which the sustain discharge is performed in the sustain periods PS1 through PS7, thereby erasing the wall charges and performing the reset discharge between the Y electrode and the A electrode and between the Y electrode and the X electrode. As in the embodiment of FIGS. 3-8, the reset discharge is selectively performed according to whether the sustain discharge has been previously performed.

The address periods PA1 through PA8 are periods when a discharge cell that is turned on or off is selected from all the discharge cells during the address discharge. In one embodiment, as shown in FIG. 13, scan pulses having a high level electric potential Vsch2 and a low level electric potential Vscl2 are sequentially applied to the Y electrode, and the display data signal having the high level 2 Va2 is applied to the A electrode in accordance with the low level electric potential Vscl2 of the scan pulse, and the bias voltage Vb2 is continuously applied to the X electrode. The application of the scan pulse and the display data signal results in the performance of the address discharge between the Y electrode and the A electrode of the discharge cells. After the address discharge is performed, positive wall charges are accumulated around the Y electrode, negative wall charges are accumulated around the A electrode, and negative wall charges are accumulated around the X electrode.

The sustain periods PS1 through PS8 are periods when the sustain discharge is performed according to the gray-level weights assigned to the discharge cell that is turned on. Sustain pulses having the high level Vs2 and a low level Vg are alternately applied to the Y electrode and the X electrode, and an electric potential Vg is applied to the A electrode. A high level electric potential of the sustain pulse is referred to as a sustain discharge voltage Vs2. If the sustain pulse of the high level Vs2 is applied to the Y electrode, the sustain discharge is performed by the positive wall charges accumulated around the Y electrode of the discharge cells, the negative wall charges accumulated around the X electrode, the electric potential Vs2 applied to the Y electrode, and the electric potential Vg applied to the X electrode. After the sustain discharge is performed, the positive wall charges and the negative wall charges are accumulated around the X electrode and the Y electrode, respectively. If of the sustain pulse of the high level Vs2 is applied to the X electrode, the sustain discharge is performed by the negative wall charges accumulated around the Y electrode of the discharge cells, the positive wall charges accumulated around the X electrode, the electric potential Vg applied to the Y electrode, and the electric potential Vs2 applied to the X electrode. After the sustain discharge is performed, the negative wall charges and the positive wall charges are accumulated around the X electrode and the Y electrode, respectively. Therefore, the sustain discharge is continuously performed according to the number of sustain pulses determined by the gray-level weights.

As described above, the PDP having a new structure according to one embodiment of the present invention improves a light-emitting efficiency and reduces a permanent afterimage.

In one embodiment, the reset discharge is performed in all discharge cells in the reset periods of the first sub-field, whereas the reset discharge is performed in a discharge cell in which the sustain discharge is performed in the sustain periods in the reset periods of the second through eighth sub-fields.

The reset discharge is selectively performed according to the sustain discharge performed in the sustain periods, thereby reducing an unnecessary reset light and improving a contrast of the PDP.

The second through eighth reset periods of the second through eighth sub-fields can be shorter than the first rest period of the first sub-field, and the shorter reset period can be assigned to the address period according to a high quality PDP, thereby performing a stable discharge.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of driving a plasma display panel (PDP) including i) first and second substrates spaced apart from each other, ii) a barrier rib, in conjunction with the first and second substrates, partitioning discharge cells and iii) first and second electrodes extending to cross each other within the barrier rib, the method comprising:
applying first and second reset pulses, which are different from each other, to the first electrode during at least two adjacent reset periods, respectively, so as to initialize discharge cells;
performing an address discharge so as to select a discharge cell that is turned on or off; and
performing a sustain discharge for a discharge cell selected to be turned on by the address discharge,
wherein a display image is represented by a plurality of unit frames and each unit frame is divided into a plurality of sub-fields, and each of the sub-fields includes, in order, a reset period, an address period for the address discharge and a sustain period for the sustain discharge,
wherein the first reset pulse is applied so as to initialize all discharge cells in a given sub-field of the unit frame, and wherein the second reset pulse is applied so as to initialize only discharge cells, in which a sustain discharge has been previously performed in the sustain periods, in the subsequent sub-fields of the unit frame.

2. The method of claim 1, wherein the first reset pulse includes a rising pulse and a falling pulse, and the second reset pulse includes a falling pulse.

3. The method of claim 2, wherein the rising pulse and the falling pulse are ramp pulses.

4. The method of claim 2, further comprising applying a bias voltage to the second electrode when the falling pulse is applied in the reset periods of each of the sub-fields.

5. The method of claim 2, further comprising i) applying a plurality of low level scan pulses to the first electrode, wherein the low level scan pulses are sequentially provided during each address period, and ii) applying a display data signal to the second electrode in accordance with the plurality of low level the scan pulses in the address periods of each of the sub-fields.

6. The method of claim 2, further comprising i) applying a sustain pulse alternately having a high level and a low level to the first electrode, and ii) applying a pulse having an intermediate level between the high level and the low level of the sustain pulse to the second electrode in the sustain periods of each of the sub-fields.

7. A method of driving a plasma display panel (PDP) including i) first and second substrates spaced apart from each other, ii) a barrier rib, in conjunction with the first and second substrates, partitioning discharge cells, iii) first and second electrodes extending in a direction within the barrier rib and iv) a third electrode extending to cross the first and second electrodes within the barrier rib, the method comprising:
applying first and second reset pulses, which are different from each other, to the first electrode during at least two adjacent reset periods, respectively, so as to initialize discharge cells;
performing an address discharge so as to select a discharge cell that is turned on or off; and
performing a sustain discharge for a discharge cell selected to be turned on by the address discharge,
wherein a display image is represented by a plurality of unit frames, each unit frame is divided into a plurality of sub-fields, and each of the sub-fields includes, in order, a reset period, an address period for the address discharge, and a sustain period for the sustain discharge,
wherein the first reset pulse is applied so as to initialize all discharge cells in a given sub-field of the unit frame, and wherein the second reset pulse is applied so as to initialize only discharge cells, in which a sustain discharge has been previously performed in the subsequent sub-fields of the unit frame.

8. The method of claim 7, wherein the first reset pulse includes a rising pulse and a falling pulse, and the second reset pulse includes a falling pulse.

9. The method of claim 8, wherein the rising pulse and the falling pulse are ramp pulses.

10. The method of claim 8, further comprising applying a bias voltage to the second electrode when the falling pulse is applied in the reset periods of each of the sub-fields.

11. The method of claim 8, further comprising i) applying a plurality of low level scan pulses, wherein the low level scan pulses are sequentially provided during each address period, ii) applying a display data signal to the third electrode in accordance with the plurality of low level scan pulses, and iii) applying a bias voltage to the second electrode in the address periods of each of the sub-fields.

12. The method of claim 8, further comprising i) applying a plurality of sustain pulses alternately having a high level and a low level to the first electrode and the second electrode in the sustain periods of each of the sub-fields.

13. A plasma display apparatus, comprising:
a plasma display panel (PDP) including i) first and second substrates spaced apart from each other, ii) a barrier rib, in conjunction with the first and second substrates, partitioning discharge cells and iii) first and second electrodes extending to cross each other within the barrier rib; and
drivers configured to apply diving signals in reset, address, and sustain periods to each of the first and second electrodes to drive the PDP, wherein a display image is represented by a plurality of unit frames, and each unit frame is divided into a plurality of sub-fields, and each of the sub-fields includes, in order, the reset period for initializing discharge cells, the address period for selecting a discharge cell that is turned on or off, and the sustain period for performing a sustain discharge on a discharge cell selected to be turned on in the address period,
wherein the drivers include a first driver configured to apply a first driving signal to the first electrode, and a second driver configured to apply a second driving signal to the second electrode,
and wherein the first driver is further configured to apply a rising pulse and a falling pulse during a reset period in a given sub-field of each unit frame, and apply the falling pulse during reset periods in the subsequent sub-fields of the unit frame.

14. The plasma display apparatus of claim 13, wherein the rising pulse and the falling pulse are ramp pulses.

15. The plasma display apparatus of claim 13, wherein the second driver is further configured to apply a bias voltage when the falling pulse is applied in the reset periods of each of the sub-fields.

16. The plasma display apparatus of claim 13, wherein the first driver is further configured to apply a plurality of low level scan pulses, wherein the low level scan pulses are sequentially provided during each address period, and wherein the second driver is further configured to apply a display data signal in accordance with the plurality of low level scan pulses in the address periods of each of the sub-fields.

17. The plasma display apparatus of claim 13, wherein the first driver is further configured to apply a sustain pulse alternately having a high level and a low level, and the second driver is further configured to apply an intermediate level pulse between the high level and the low level of the sustain pulse in the sustain periods of each of the sub-fields.

18. A plasma display apparatus, comprising:
a plasma display panel (PDP) including i) first and second substrates spaced apart from each other, ii) a barrier rib, in conjunction with the first and second substrates, partitioning discharge cells, iii) first and second electrodes extending in a direction within the barrier rib and iv) a third electrode extending to cross the first and second electrodes within the barrier rib; and
drivers configured to apply diving signals in reset, address, and sustain periods to each of the first, second, and third electrodes to drive the PDP, wherein a display image is represented by a plurality of unit frames, and each unit frame is divided into a plurality of sub-fields, and each of the sub-fields includes, in order, the reset period for initializing discharge cells, the address period for selecting a discharge cell that is turned on or off, and the sustain period for performing a sustain discharge on a discharge cell selected to be turned on in the address period,
wherein the drivers include a first driver configured to apply a first driving signal to the first electrode, a second driver configured to apply a second driving signal to the second electrode, and a third driver configured to apply a third driving signal to the third electrode,
and wherein the first driver is further configured to apply a first reset discharge pulse including a rising pulse and a falling pulse during a reset period in a given sub-field of each unit frame, and apply a second reset discharge pulse including a falling pulse during reset periods in the subsequent sub-fields of the unit frame.

19. The plasma display apparatus of claim 18, wherein the rising pulse and the falling pulse are ramp pulses.

20. The method of claim 1, wherein the first reset pulse is applied in the first sub-field of the unit frame.

21. The plasma display apparatus of claim 13, wherein the given sub-field is the first sub-field of the unit frame.

22. The plasma display apparatus of claim 18, wherein the first reset discharge pulse is applied in the first sub-field of the unit frame.
